(19) United States
(12) Patent Application Publication
(10) Pub. No.: US 2005/0102322 A1
(43) Pub. Date: May 12, 2005

(54) Creation of knowledge and content for a learning content management system

(75) Inventors: Elizabeth Vera Bagley, Cedar Park, TX (US); Pamela Ann Nesbitt, Tampa, FL (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/703,015

(22) Filed: Nov. 6, 2003

(51) Int. Cl. G06F 17/00

(52) U.S. Cl. 707/104.1

(57) ABSTRACT

A mechanism is provided that automates the creation of learning objects from knowledge and learning content in various common formats. Importing is performed using a tool with custom parsers for common formats. The parsers split the content into learning objects, generate metadata, and relate metadata to the objects. The tool may also provide points of integration for making new parsers available through the tool, Candidate content may be presented to user by searching the local file system. Search engine output may be used to present the candidate list.

### BACKGROUND OF THE INVENTION

1. Technical Field

The present invention relates to data processing and, in particular, to learning content management and delivery. Still more particularly, the present invention provides a method, apparatus, and program for creation of knowledge and content for a learning content management system.

2. Description of Related Art

Electronic-learning (e-learning) is an umbrella term for providing computer instruction online over the Internet, private distance learning networks or in-house via an intranet. Computer based training (CBT) uses a computer for training and instruction. CBT programs are called “courseware” and provide interactive training sessions for all disciplines. CBT courseware is typically developed with authoring languages that are designed to create interactive question/answer sessions.

A learning management system (LMS) is an information system that administers instructor-led and e-learning courses and keeps track of student progress. An LMS may be used internally by large enterprises for their employees. An LMS may be used to monitor the effectiveness of an organization's education and training.

A learning content management system is software that manages learning content for e-learning. A LCMS provides for the storage, maintenance, and retrieval of documents, such as hyptertext markup language (HTML) and extensible markup language (XML) documents, and all related elements. For example, learning content management systems may be built on top of a native XML database and provide publishing capabilities to export content to a Web site, CD-ROM, or print.

Currently, when using a LCMS (i.e. entering content into the LCMS), customers must manually parse existing whole courses into discrete learning objects and manually associate metadata with the objects. This manual effort is intensive and reduces immediate return on investment for the conformant metadata with the objects. Current LCMS implementations focus on drawing new content into the repository. However, current LCMS implementations do not provide a method for automating the import of legacy content and automatically deriving metadata for the legacy content.

As the e-learning industry shifts to a blended approach of knowledge content management and learning content management, legacy knowledge content of various formats will also need to be added to the LCMS. As is true for legacy learning content, this is currently a manually intensive effort.

Therefore, it would be advantageous to provide an improved mechanism for the automatic creation of knowledge and content for a learning content management system.

### SUMMARY OF THE INVENTION

The present invention is a mechanism that automates the creation of learning objects from knowledge and learning content in various common formats. Importing is performed using a tool with custom parsers for common formats. The parsers split the content into learning objects, generate metadata, and relate metadata to the objects. The tool may also provide points of integration for making new parsers available through the tool. Candidate content may be presented to the user by searching the local file system. Search engine output may be used to present the candidate list.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a block diagram depicting a tool for automating the creation of knowledge and learning content in a learning content management system according to a preferred embodiment of the present invention;

FIG. 5 is an example screen for running a parser from a graphical user interface in accordance with a preferred embodiment of the present invention;

FIG. 6 is an example screen from a graphical user interface for entering information when parsing content in accordance with a preferred embodiment of the present invention;

FIG. 7 illustrates the GUI elements and metadata entities to which the GUI elements map in accordance with an exemplary embodiment of the present invention;

FIGS. 8A-8C illustrate the operation of identification of content in an example unit file in accordance with a preferred embodiment of the present invention;

FIGS. 9A and 9B illustrate example content and associated metadata in accordance with a preferred embodiment of the present invention;

FIG. 10 is a block diagram illustrating example learning content with nested objects in accordance with a preferred embodiment of the present invention;

FIG. 11 illustrates the content nests by level in accordance with a preferred embodiment of the present invention; and

FIG. 12 is a flowchart illustrating the operation of a learning object creation tool in accordance with a preferred embodiment of the present invention.

### DETAILED DESCRIPTION OF THE PREFERRED EMBODIMENT

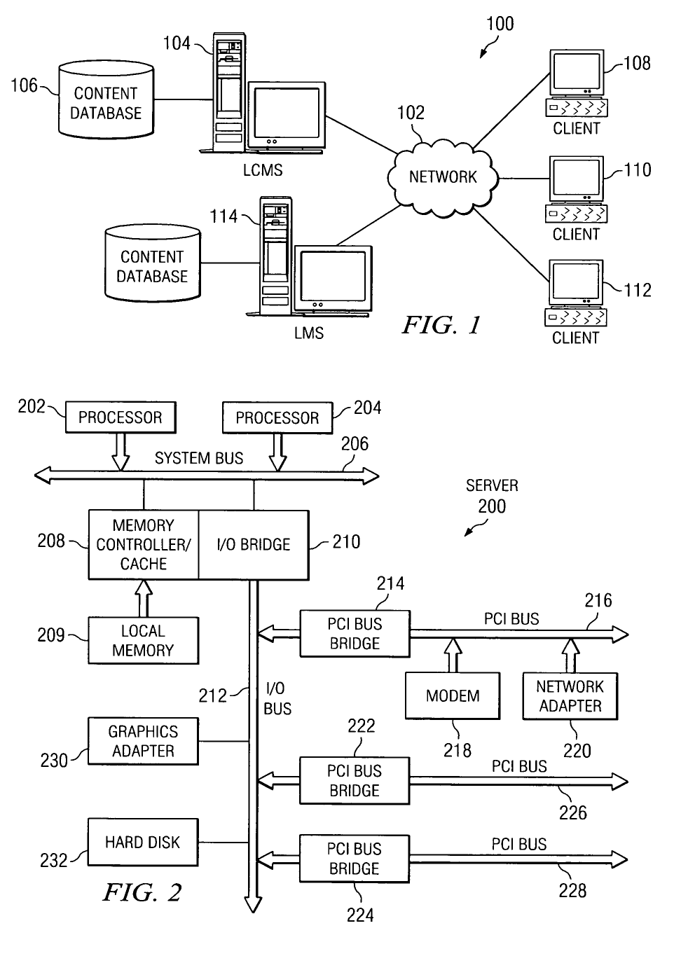

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, learning content management system (LCMS) is implemented in server 104, which is connected to network 102 and provides for the storage, maintenance, and retrieval of documents, such as hyptertext markup language (HTML) and extensible markup language (XML) documents, and all related elements in content database 106. For example, the learning content management systems may be built on top of a native XML database and provide publishing capabilities to export content to a Web site, CD-ROM, or print. Learning content is information that is intended to be rendered in a learning experience. Knowledge content is content from a source other than educational materials. Knowledge content may be assimilated into learning content.

In the depicted example, learning management system (LMS) may be implemented in server 114. The LMS administers instructor-led and e-learning courses and keeps track of student progress. The LMS may deliver learning content from content database 106. Alternatively, the content database may be connected to server 114. The LMS may be used to monitor the effectiveness of an organization's education and training. The LMS, like the LCMS may be implemented in a server, which may include a Web server or the like.

In addition, clients 108, 110, and 112 are connected to network 102. These clients 108, 110, and 112 may be, for example, personal computers or network computers. In the depicted example, LCMS server 104 or LMS server 114 may provide learning content, such as coursework, to clients 108-112. Clients 108, 110, and 112 are clients to server 104. Network data processing system 100 may include additional servers, clients, and other devices not shown.

Alternatively, a LCMS may include learning content delivery functionality and, similarly, a LMS may include content management functionality. However, in accordance with a preferred embodiment of the present invention, the LCMS includes a tool that automates the creation of learning objects from knowledge and learning content in various common formats. Importing is performed using a tool with custom parsers for common formats and a generic parser that splits the content into learning objects, generates metadata, and relate metadata to the objects. The tool may also provide points of integration for making new parsers available through the tool. Candidate content may be presented to user by searching the local file system. Search engine output may be used to present the candidate list.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pseries system, a product of International Business Machines Corporation in Armonk, N.Y., running the Advanced Interactive Executive (AIX) operating system or LINUX operating system.

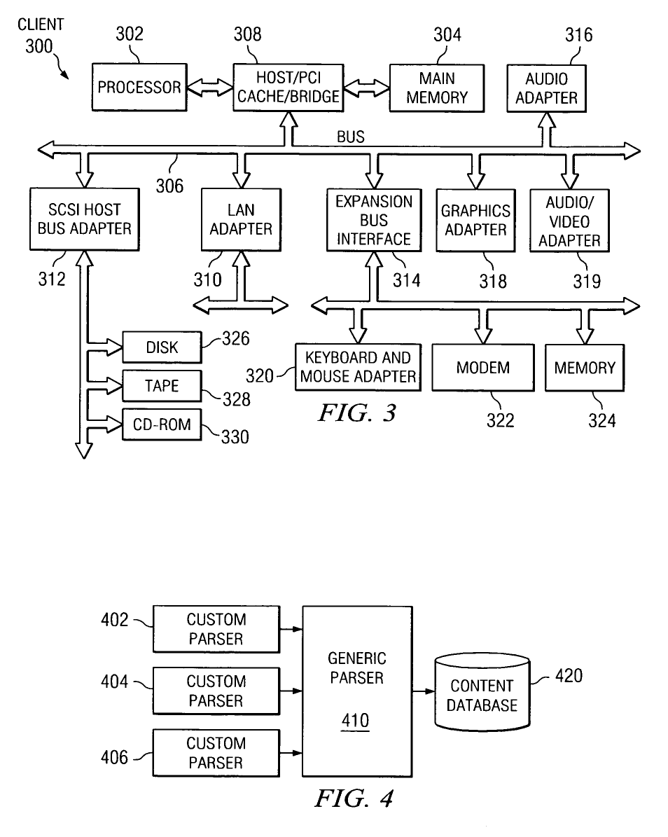

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards.

In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

FIG. 4 is a block diagram depicting a tool for automating the creation and management of knowledge and learning content in a learning content management system according to a preferred embodiment of the present invention. The automation tool includes a plurality of custom parsers 402, 404, 406. Each custom parser parses content in a common format, such as hypertext markup language (HTML), presentation software formats, word processing software formats, etc. The format of content to be imported may be selected using a user interface, such as a graphical user interface (GUI) or the like.

The custom parsers transcode content, such as whole courses, from given formats to well-structured documents. The well-structured documents may be in a markup language, such as HTML or XML, for example. Custom parsers 402, 404, 406 are designed with the knowledge of the particular content format. The custom parsers may include more or less intelligence based upon the complexity of the content format. As an example, a custom parser for HTML content may divide the content into learning objects, such as chapters, sections, subsections, etc., based upon header levels. As another example, a custom parser for word processing content may divide the content into learning objects based upon numbering tags.

The transcoded documents are provided to generic parser 410. The generic parser operates on the well-structured documents and parses the content into learning objects. Generic parser 410 automatically derives and associates learning object metadata with the learning objects. The learning object metadata may be Learning Object Metadata (LOM) or Shareable Content Object Reference Model (SCORM) conformant metadata. For more information on LOM, see Draft Standard for Learning Object Metadata, Jul. 15, 2002, IEEE 1484.12.1-2002, which is herein incorporated by reference. For more information on SCORM, see The Advanced Distributed Learning Sharable Content Object Reference Model Content Aggregation Model, Version 1.2, which is herein incorporated by reference. The metadata may include, for example, file size, multipurpose Internet mail extension (MIME) type, technical requirements, author, and date.

The tool generates and stores object relationships using the metadata so that units, chapters, lessons, subsections, sections, etc. may be reconstructed when needed. For example, the tool may relate the metadata to the content objects through IMS6 conformant XML Manifest metadata. For information on IMS Manifest metadata, see IMS Learning Resource Metadata XML Binding Specification, Version 1.2, which is herein incorporated by reference.

The tool then populates content database 420 with all metadata and content objects. The content database may be, for example, a standards-conformant LCMS repository for managing knowledge and learning content. The content database may also be used to deliver the learning content as coursework.

The tool automates the creation of learning objects from knowledge and learning content in various common formats. The tool may also provide points of integration for making new parsers available through the tool. Candidate content may be presented to user by searching the local file system. Search engine output may be used to present the candidate list.

In an example custom parser implementation, a custom parser is created for instructor-led courses developed in Framemaker, so that the content and graphics could subsequently be transformed into specific Web-based training templates and a particular site structure used to deliver Web-based training.

Rather than developing a custom parser to parse the original Framemaker file, which is a possible alternative, the exemplary implementation starts with the input of the Framemaker files saved as HTML.

Each unit is a Framemaker file (.fm) that contains text, graphic, paragraph styles, and character styles. Each unit is saved as HTML in a directory by the name of the unit. The input structure is as shown, with the HTML files and graphics in each unit folder.

Cours _folder

Unit_1

Unit_1.htm
Graphic1.gif
Graphic2.gif
Graphic3.gif

Unit_2

Unit_2.htm
Ex1.gif
Ex9.gif
...

...

The custom parser for the Framemaker documents requires that the person create a load file, such as loadfile.txt, that identifies which units are to be parsed into the repository. It is possible that the Framemaker table of contents could be used for this particular implementation; however, course developers may prefer to be able to specify which units are actually imported into the repository for future use.

The load file contains one line per unit to be parsed and resides at the top level of the course folder.

Example Load File:

Unit_{—}1
Unit_{—}2

In the example implementation of the parser, the base required SCORM 1.2 metadata tags plus those metadata tags of interest are identified. The tags that can be auto-derived by the parsers and which initial “seed” input is required by the user are also identified.

To handle the metadata entities that could not be easily derived, a graphical user interface (GUI) allows users to enter the seed data.

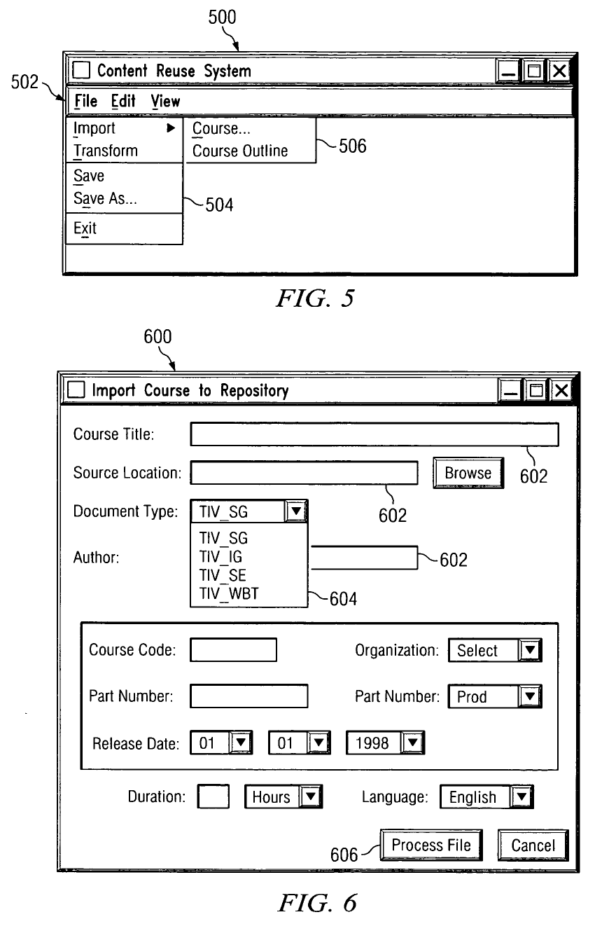

FIG. 5 is an example screen of display for running a parser from a graphical user interface in accordance with a preferred embodiment of the present invention. Graphical user interface 500 includes menu bar 502 including menus for entering commands. In the depicted example, expanded “File” menu 504 is presented responsive to the “File” menu in menu bar 502 being selected. The “File” menu includes selections for “Import,” “Transform,” “Save,” “Save As,” and “Exit.”

In the depicted example, expanded “Import” menu 506 is presented responsive to “Import” being selected in menu 504. “Import” menu 506 includes selections for “Course,” and “Course Outline.” Selection of “Course” launches a graphical user interface for selecting content type and for entering particular metadata, such as course title, source location, author, and so forth.

With reference to FIG. 6, an example graphical user interface for selection of information for parsing content is shown in accordance with a preferred embodiment of the present invention. Graphical user interface 600 includes input fields 602 for entering minimal metadata manually for the learning content. In the depicted example, the input fields include a “Course Title” field, a “Source Location” field, and an “Author” field. The GUI may include other input fields, as shown in FIG. 6. Furthermore, GUI 600 may include more or fewer input fields depending upon the implementation or the actual content type. For example, a course title or author may be identified from the content itself using HTML tags or the like.

GUI 600 also includes input field 604, which may be a drop-down box for selecting from known content types. The known content types may include, for example, student guides, instructor guides, student exercises (all from books), and a Web course (Web-Based Training). The custom parser is selected based upon the content type selected in input field 604.

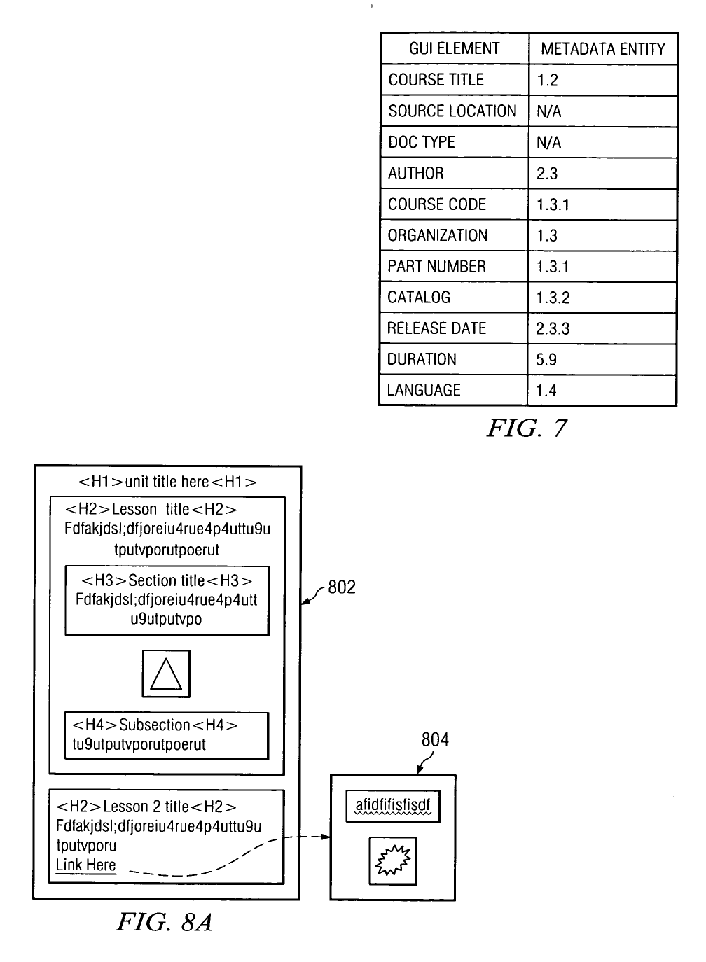

FIG. 7 illustrates the GUI elements and metadata entities to which the GUI elements map in accordance with an exemplary embodiment of the present invention. Once the seed metadata entities are filled by the user, the user clicks “Process File” button 606. This starts the custom parser that corresponds to the Doc Type that the user selected.

Source location is used to identify the location o source to be imported by the parser. Document type is used to identify the custom parser that will import the content. The custom parser reads in the load file that resides in a source location identified by the user. The custom parser then opens a hypertext markup language (HTML) file for each unit that resides in an identified unit folder. The custom parser may also perform some “clean up” tasks. These are defined below.

Cleaning and Simplifying HTML Content

The parser includes regular expressions and other code to clean and simplify source HTML content. The parser simplifies the heading tags to basic “Hn” identifiers. This level information is used to identify reusable chunks and to determine the organizational metadata (course/object structure) for the IMS Manifest files for nested content objects. When content is reused, headings are adjusted to match their new position.

Over time, with multiple changes in formatting standards, the tags to identify headings can vary substantially from one course to another. Because of the application of multiple templates throughout the history of a course, for example, it is common for the more mature courses to contain a number of different tags, all representing the same heading level. The parser contains the rules to convert the headings defined in the legacy content to a simplified HTML heading. Table 1 below illustrates different representations of the same common level.

TABLE 1
Different Representations of Same Content Level
(Converted to <H3> in 3CS Proof-of-concept)

<P CLASS=“H3F-Heading-3-Flow”>
<H3 CLASS=“H3F-Heading-3-Flow”>
<H3 CLASS=“H3F-Heading3-Flow”>
<H3 CLASS=“H3-Heading-3-Flow”>

Additionally, there are situations where an item appearing in the same location is given a different heading level in different Framemaker templates. The parser contains the regular expression substitutions to homogenize and simplify HTML headings. Table 2 below illustrates examples of different levels for the same content.

TABLE 2
Examples of Different Levels for Same Content

<H3 CLASS=“O-Objectives”>
<H4 CLASS=“O-Objectives”>

Note that the substitution values will impact the transform. Consider that lessons are at the same level as the H3 Objectives heading. What that means is that the Objective page will be formatted however a Lesson page is formatted, if a substitution value of “<H3>” is selected to replace “<H3 CLASS=“O-Objectives”>” and “<H4 CLASS=“O-Objectives”>.”

In some legacy content, heading levels are chosen by their appearance within the browser, rather than as an indicator of level within a structured document. In those cases, the 3CS Parser substitutions map the existing heading level to the desired level in a structured document. Table 3 below illustrates an example mapping of heading levels.

TABLE 3
Example: Mapping of Levels

<H1> in Lesson Index file (WBT) is mapped
to <H2> for 3CS Repository

The Tiv_SG parser eliminates extra, unnecessary HTML tags generated when doing a Save-as HTML from Framemaker files with IBM Tivoli Education character and paragraph templated styles. Table 4 illustrates examples of unnecessary HTML elements.

TABLE 4
Examples of Unnecessary HTML
(Eliminated by 3CS Parser)

<P>&nbsp;</P>
<A NAME=pgfId-[0-9]*″></A>
<Div></Div>
&nbsp;

Certain characters cause the SCORM-conformant XML files storing metadata to be malformed. For example, if a special character appears in the first fifty words of a chunk of HTML, the special character might be used within the description metadata field, which would break the XML file.

The 3CS parser eliminates certain special characters that appear in the legacy content files. An alternative solution may be to find a suitable text-based replacement. Table 5 below illustrates examples of problematic characters that may be eliminated by a custom parser.

TABLE 5
Examples of Problematic Characters
(in Hex) Eliminated by Parser
x96
x97
xAE

To further add to the complexity of identifying headings and related content chunks, various HTML editors and save-as HTML functions produce headings. Heading tags may span multiple lines and often contain other nested tags. The 3CS Parser may employ regular expression substitutions to simplify tags spanning multiple lines. Table 6 below illustrates examples of multi-line tags that may be eliminated by a custom parser.

TABLE 6
Examples of Eliminating Multi-line Tags

| | |
|---|---|
| Before | <H2 CLASS=“H2-Heading-2”> <A |
| | NAME=“pgfId-1023083”></A> |
| | <DIV> <IMG SRC=“Unit2_SG-4.gif”> |
| | </DIV> |
| | <A NAME=“77588”></A>Server |
| | Installation</H2> |
| After | <H2>Server Installation</H2> |

Once the Custom Parser has massaged the content into clean, well-structured HTML files for the generic parser, the generic parser handles the work of deriving the metadata that can be automatically set, as described in the metadata table below, chunking the content, and identifying nested levels of objects (units, lessons, sections, subsections, etc).

Chunking of Content by the Generic Parser

Course developers may want to reuse units, lessons, sections, subsections, entire courses, or specific media objects, such as an image file, a video file file, or a Macromedia Flash file, when creating a new course or updating an existing course.

The generic parser chunks content objects on the “Hn” tags in the HTML files provided by the custom parsers. The generic parser then generates a unique object ID for the HTML object and generates metadata conforming to SCORM 1.2. The content chunk is delimited with markers to identify the chunk as belonging to a particular object. This is not of immediate importance, but will be valuable in efforts to manage versioning and to propagate changes or notify course developers regarding changes to courses reusing the object. All paths to embedded media or links to media container objects are replaced with a file name, so that the media can be stored with less effort to adjust paths. This is helpful because the tool of the present invention is not integrated with a relational database management system, and the transforms must also adjust paths to meet the requirements of the desired output format.

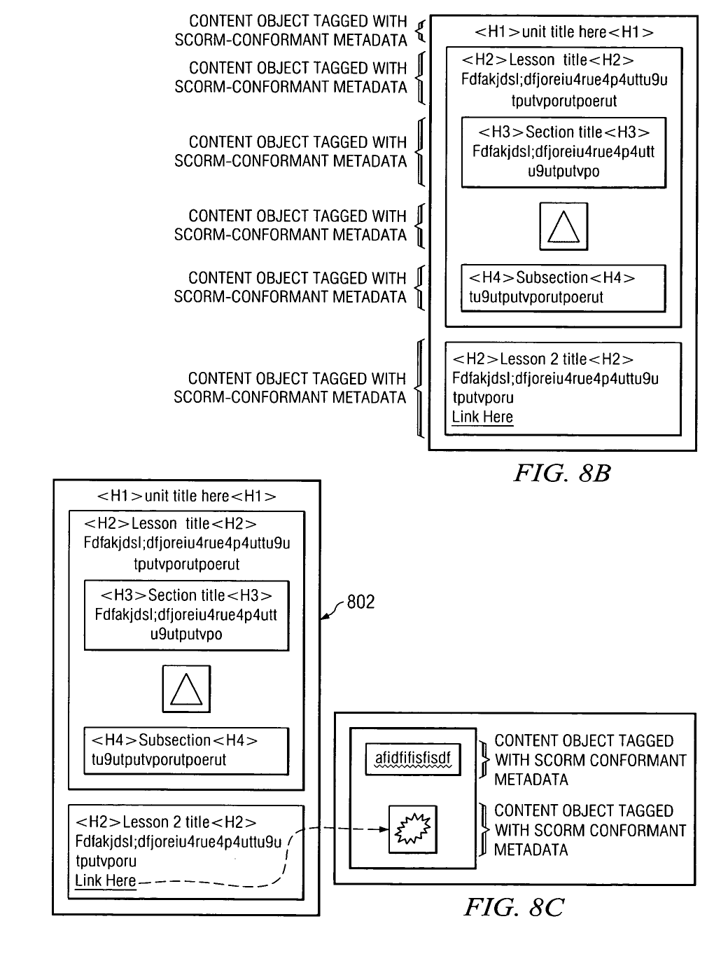

FIGS. 8A-8C illustrate the operation of identification of content in an example unit file in accordance with a preferred embodiment of the present invention. More particularly, with reference to FIG. 8A, unit file 802 includes a title in “<H1>” tags, two lessons in “<H2>” tags, a section defined by an “<H3>” tag, a graphic depicted by a triangle, a subsection identified by an “<H4>” tag, and a link to a second page 804. The content between each header tag is stored as an object and tagged with learning object metadata. The graphic is also tagged with learning object metadata and stored as an asset in the repository.

The diagrams in FIGS. 8B and 8C demonstrate the content objects with learning object metadata that the generic parser parses into the repository. Asset XML files are used to store asset metadata for each of the artifacts shown with a brace. The generic parser also scans the HTML object for embedded objects and links to HTML container objects in which Macromedia Flash files (SWF) and video files reside. An object ID and metadata are subsequently generated for each multimedia object found.

All object files and XML metadata files are then copied to a folder, named according to the Part Number of the object that was parsed, created at the top level of the repository. Another exemplary embodiment of the present invention may tie into a relational database.

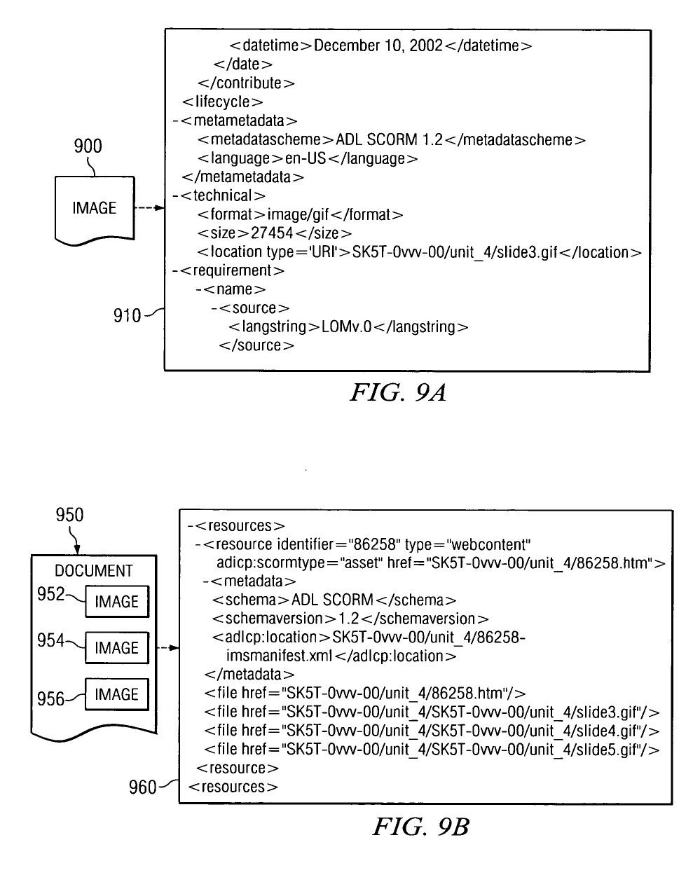

FIGS. 9A and 9B illustrate example content and associated metadata in accordance with a preferred embodiment of the present invention. More particularly, with reference to FIG. 9A, the learning content includes image 900, which may be a graphics interchange format file (GIF) image. A portion of the corresponding metadata present in the SCORM-conformant Manifest is shown as 910.

For each reusable object encountered through parsing, the generic parser generates a unique object ID, this are sequentially assigned with the last used object ID being stored in a file in the configuration directory. This unique object ID is expected to eventually be used as the unique identifier for objects within a relational database management system. At this time, the object IDs are used as unique object identifiers within the XML metadata files (CatalogEntry.Catalog of the ObjID) and are used in the naming of the HTML asset XML files and XML manifests.

Because it is slightly more difficult to rename media files linked in from parent HTML container files, the generic parser leaves multimedia objects as named in the legacy content. The associated XML file follows a naming convention of mediafile-extension.xml.

For HTML chunks, the ObjID entry is used to name the chunk of HTML. For example, when the parser locates a header and parses an HTML chunk with an automatically generated ObjID of 34323, the HTML asset file is named “34323.htm” and the associated asset XML file is named “34323-htm.xml.”

Each Asset XML file contains the structure identified in Table 6 below. Notice that many of these metadata elements are automatically derived by the generic parser.

TABLE 6

| Nr | Name | Explanation | Multiplicity | Data Type |
|---|---|---|---|---|
| 1 | General | Groups the general info that describes object as | 1 and only 1 | Container |
| | REQUIRED | a whole. | | |
| 1.1 | Identifier | Globally unique label that identifies the | RESERVED | String |
| | | resource. Reserved and not used. Can be | | |
| | | created by metadata mgt system | | |
| 1.2 | Title | Name of resource. For the Parser, this is | 1 and only 1 | LangString max |
| | REQUIRED | populated from the nearest <H> heading | | of 1000 |
| | AUTO-SET | | | characters |
| 1.3 | Catalog | Actual value of the catalog entry or listing | 0 or More | Container |
| | Entry | identification system | Smallest | |
| | SEED | | max of 10 | |
| 1.3.1 | Catalog | Unique object ID for each object in the 3CS | 0 or 1 | String (smallest |
| | AUTO-SET | repository. ObjID. | | max is 1000) |
| 1.3.2 | Entry | Auto-generated by incrementing the last used | 0 or more | |
| | AUTO-SET | object ID. | (smallest | |
| | | | maximum is | |
| | | | 10) | |
| 1.3 | Catalog | Actual value of the catalog entry or listing | 0 or More | Container |
| | Entry | identification system | Smallest | |
| | SEED | | max of 10 | |
| 1.3.1 | Catalog | Part number related to the course from which | 0 or 1 | String (smallest |
| | SEED | the original legacy content was extracted. | | max is 1000) |
| 1.3.2 | Entry | Part number | 0 or more | |
| | SEED | | (smallest | |
| | | | maximum is | |
| | | | 10) | |
| 1.3 | Catalog | Actual value of the catalog entry or listing | 0 or More | Container |
| | Entry | identification system | Smallest | |
| | SEED | | max of 10 | |
| 1.3.1 | Catalog | Organization name. Identifies the type of | 0 or 1 | String (smallest |
| | SEED | training object from which the content was | | max is 1000) |
| | | parsed. | | |
| 1.3.2 | Entry | Tiv_SG, Tiv_WBT, etc. | 0 or more | |
| | SEED | | (smallest | |
| | | | maximum is | |
| | | | 10) | |
| 1.4 | Language | Primary human language used within the | 0 or more | String (smallest |
| | SEED | resource to communicate with students. Parser | (smallest | permitted |
| | | for existing course materials sets content to | permitted | maximum 100 |
| | | US_en, according to the seed input. | max: 10) | characters) |
| 1.5 | Description | Text description of the content of the resource. | 1 or More | LangStringType |
| | AUTO-SET | This is a required field. If a content object | (smallest | (smallest max is |
| | | contains no text, the title for the object is used. | max is 10) | 2000 |
| | | If the object is an embedded multimedia object, | | characters) |
| | | the description is taken from that of the parent | | |
| | | object. | | |
| 1.6 | Keyword | Keywords describing the resource. These are | 0 or More | LangStringType |
| | AUTO-SET | auto-generated for each chunk of content by | (smallest | (1000) |
| | | using a very simple keyword generator. | max is 10) | |
| 2 | Life Cycle | Describes History and current state of resource | 0 or 1 | Container |
| | | and those who affected It during its life | | |
| 2.1 | Version | Edition of this resource 1.0 for all first Imports of | 0 or 1 | LangString |
| | AUTO-SET | objects. Revision control was not implemented, | | Type (smallest |
| | | but could be. | | permitted max |
| | | | | of 50 char) |
| 2.2 | Status | State or Condition Resource is in IEEE LOM | 0 or 1 | VocabType |
| | AUTO-SET | Vocab: Draft, Final, Revised Unavailable. | | (Restricted) |
| | | Parser will set state to Final for all legacy | | |
| 2.3 | Contribute | Describes people or orgs that affected state of | 0 or More | Smallest |
| | SEED | object during evolution | | permitted max: |
| | | | | 30 |
| 2.3.1 | Role | Kind of Contribution. | 0 or 1 | VocabularyType |
| | AUTO-SET | Sets the Content Provider to the primary course | | (Best Practice) |
| | | developer assigned to the course being | | |
| | | imported into the repository | | |
| 2.3.3 | Date | Defines date of contribution. This is the date | 0 or 1 | DateType |
| | SEED | that the training materials were handed over to | | |
| | | production. | | |
| 3 | Meta- | Specific info about this meta-data record itself. | 1 and only 1 | Container |
| | Metadata | | | |
| | REQUIRED | | | |
| 3.4 | Metadata | Name and version of the authoritative spec | 1 or More | String (Smallest |
| | Scheme | used to create this metadata instance. Sets this | (Smallest | permitted max |
| | REQUIRED | to ADL SCORM 1.2. | permitted | 30 ch) |
| | AUTO-SET | | Max: 10) | |
| 4 | Technical | Tech req's and characteristics of the resource | 1 and only 1 | Container |
| | REQUIRED | | | |
| 4.1 | Format | Tech data type of this resource. Either a MIME | 1 or More | String (smallest |
| | REQUIRED | type or “non-digital.” We use the MIME Type, | (smallest | max: 500 ch) |
| | AUTO-SET | auto-entered via mapping of object to MIME | max: 40) | |
| | | type (Config File) | | |
| 4.2 | Size | Size in bytes. This is the uncompressed size, as | 0 or 1 | String (smallest |
| | AUTO-SET | automatically derived. | | max 30 ch) |
| 4.3 | Location | String used to access resource. Location (URL | | |
| | AUTO-SET | or method that resolves to location URI. | | |
| | | Relative URL is ok if relative to location of | | |
| | | metadata record. Our implementation is | | |
| | | filesystem based; whereas next phase | | |
| | | integrates RDBMS. Location is relative to root | | |
| | | of repository. | | |
| 4.4 | Requirement | Describes technical capabilities required to use | 0 or More | Container |
| | | the resource | (smallest | |
| | | | max: 40) | |
| 4.4.1 | Type | The technology required to use this resource, ie | 0 or 1 | Vocab Type |
| | AUTO-SET | hardware, software, network, etc. | | (Best Practice) |
| | | IEEE LOM Vocab: Operating System, Browser | | |
| 4.4.2 | Nam | Name of the required technology to use this | 0 or 1 | Vocabulary |
| | AUTO-SET | resource. IEEE LOM Vocab | | Type (Best |
| | | If 4.4.1: | | Practice) |
| | | Technical.Requirements.Type = “Operating | | |
| | | System” PC-DOS, MS-Windows, MacOS, Unix, | | |
| | | Multi-OS, Other, None. | | |
| | | If | | |
| | | 4.4.1: Technical.Requirements.Type = “Browser” | | |
| | | Any, Netscape Communicator, Microsoft | | |
| | | Internet Explorer, Opera | | |
| | | 4.4.1 :Technical.Requirements.Type = “something | | |
| | | else . . . ”, then open vocabulary | | |
| | | This is auto-derived from 4.1: Technical.Format | | |
| | | e.g., “video/mpeg” implies Multi-OS. | | |
| 4.4.3 | Minimum | Lowest possible version of the required | 0 or 1 | String (smallest |
| | Version | technology to use this resource. Auto-derives | | max: 30 char) |
| | AUTO-SET | this from our supported platforms and MIME | | |
| | | configuration file. | | |
| 4.5 | Installation | How to install resource. This is auto-provided by | 0 or 1 | LangString |
| | Remarks | the MIME configuration file. At this time, AVI | | Type smallest |
| | AUTO-SET | and SWF instructions are provided. | | max 1000 ch |
| 6 | Rights | Describes intellectual property rights and | 1 and only 1 | Container |
| | REQUIRED | conditions of use for this resource | | |
| 6.1 | Cost | Whether resource requires payment. IEEE | 1 and only 1 | Vocab Type |
| | REQUIRED | LOM Vocab: yes, no. All set to “yes” in proof-of- | | (Restricted) |
| | AUTO-SET | concept. | | |
| 6.2 | Copyright | Whether copyright or other restrictions apply. | 1 and only 1 | Vocab Type |
| | and Other | IEEE LOM Vocab: yes, no. Set to “yes”. | | (Restricted) |
| | restrictions | | | |
| | REQUIRED | | | |
| | AUTO-SET | | | |
| 6.3 | Description | Comments on Conditions of use of this | 0 or 1 | LangString |
| | AUTO-SET | resource. This is our standard copyright | | Type (smallest |
| | | statement. Differs for WBT or ILT. Needs to be | | max 1000 ch) |
| | | variable. | | |

A text file associated with each asset contains metadata information. The following are treated as assets by the parser:
AVI
Graphic
PPT Slide Show
PDF
Word Doc (referenced by the “true” course in some existing courses)
Bock of text
Introduction, Objectives (legacy), Summary, Assessment, Copyright, Title Page Info, Instructor Notes, TOC (legacy), menus (legacy)
   Content Aggregation Meta-Data
Identified by H2+ headings in the existing training materials
ILT Student Exercises (by Unit now due to the way we currently develop materials) and Student Exercise Solutions
   The following fields are required for Aggregations, but not Assets:
1.3 catalogentry
1.3.1 catalog
1.3.2 entry
1.6 keyword
2.0 lifecycle
2.1 version
2.2 status

In many cases, a chunk of HTML content parsed from an existing Institute for Learning Technologies (ILT) course using the generic parser included embedded media. To identify the multimedia objects as separate objects that can be searched on by keywords and reused in another course, the generic parser generates unique object IDs for each multimedia object embedded in the HTML page. In addition to using asset XML files to store asset metadata, the generic parser creates a manifest file that identifies the HTML file and the embedded media as a unified content object.

In this example, the HTML file contains three embedded graphics (only two are shown). The resources section of the manifest identifies all of the files included in the reusable object package.

Turning to FIG. 9B, the learning content includes document 950, which may be a HTML document with embedded graphics that are also stored as discrete learning objects. In the depicted example, the embedded graphics include image 952, image 954, and image 956. A portion of the metadata that corresponds to HTML page 950 with embedded objects is present in the SCORM-conformant Manifest shown as 960.

The HTML page with embedded media:
86258.htm. The HTML file produced by the parser.
86258-htm.xml. Asset XML file for 86258.htm HTML content.
Slide3-gif.xml. Asset XML file for graphic Slide3.gif
Slide4-gif.xml. Asset XML file for graphic Slide4.gif
Slide5-gif.xml. Asset XML file for graphic Slide5.gif
86258-imsmanifest.xml. Aggregate file that describes the contents of the HTML file.

The generic parser uses the concept of metadata to filter, select, and assemble chunks of learning content (sharable content objects) into larger chunks of learning content. Ultimately, the implementation is expected to provide revision control and propagation of change notification. For this reason, it is important to be able to identify nested content objects and to maintain indication of both location and content changes within the smaller chunks of content and within parent objects.

As the Generic Parser encounters <Hn> tags, it pushes the object id and level onto a stack. After handling the individual asset objects, the Generic Parser defines the aggregates of objects making up each level, essentially identifying the objects that would be included in any level of object that a course developer may select for reuse.

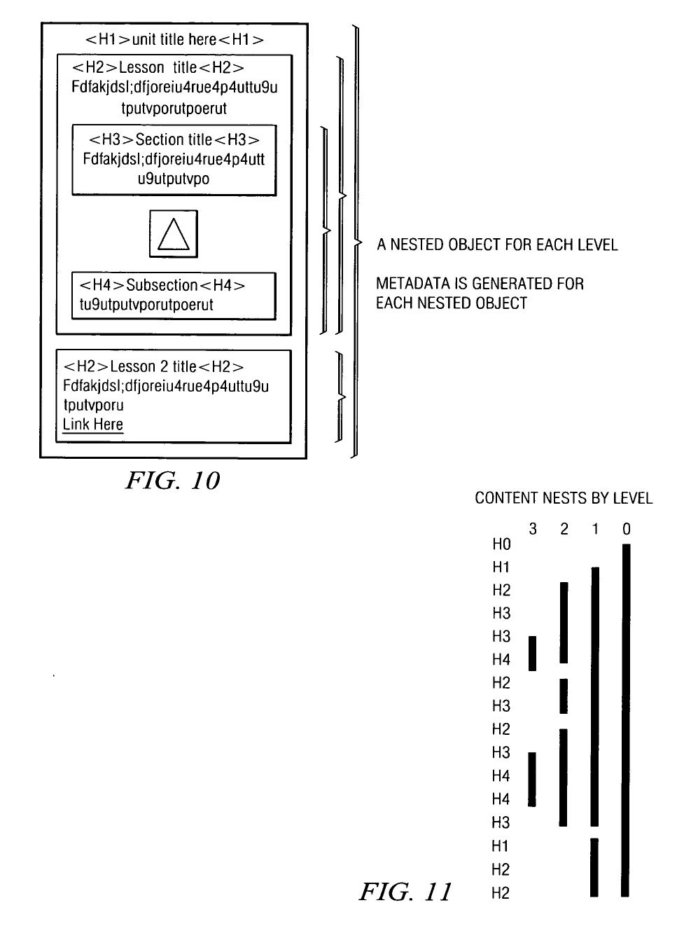

FIG. 10 is a block diagram illustrating example learning content with nested objects in accordance with a preferred embodiment of the present invention. The present invention tracks the order and HTML heading level of all course objects. After creating asset manifests for all course assets, the Generic Parser uses the nesting algorithm to create IMS manifests with organizations elements that describe the structure of the aggregate object.

FIG. 11 illustrates the content nests by level for the example shown in FIG. 10. The present invention creates the nested organizations for the IMS manifests. For each object, an asset XML file is created. Each object contains all headings less than the current heading.
Level 4. In this example, there are no headings greater than H4; therefore, H4 objects have no nests.
Level 3. Two H3 objects contain H4 objects; therefore, an IMS manifest showing the nested organization is created.
Level 2. The first manifest for a level 2 nest contains H2, H3, H3, and H4. The second contains and H2 and H3. And, the third contains H2, H3, H4, and H4.
Level 1. The parser treats H1s and Unit objects in the legacy content. There are two units described by organizations in a nested manifest file.
Level 0. The H0 is a course stub node introduced by the 3CS parser. It represents the top level course node.
   While nested objects are available for each level, the course manifest file identifies component asset objects, rather than nested manifests. However, the nested manifests can be viewed within the repository for the course.

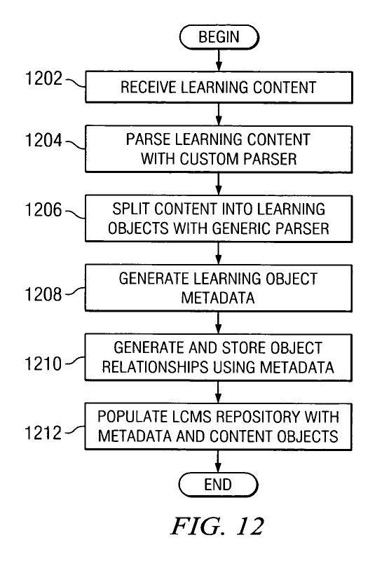

FIG. 12 is a flowchart illustrating the operation of a learning object creation tool in accordance with a preferred embodiment of the present invention. The process begins and receives learning content (step 1202). The process then parses the learning content with a custom parser corresponding to the content type (step 1204).

Thereafter, the process splits the content into learning objects with a generic parser (step 1206) and generates learning object metadata (step 1208). Next, the process generates and stores object relationships using a metadata Manifest (step 1210). Then, the process populates the LCMS repository with metadata and content objects (step 1212) and ends.

Thus, the present invention solves the disadvantages of the prior art by providing a mechanism that automates the creation of learning objects from knowledge and learning content in various common formats. Importing is performed using a tool with custom parsers for common formats. The parsers split the content into learning objects, generate metadata, and relate metadata to the objects. The tool may also provide points of integration for making new parsers available through the tool. Candidate content may be presented to user by searching the local file system. Search engine output may be used to present the candidate list.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method for creation of learning content, the method comprising:
parsing learning content using a custom parser to form at least one structured document, wherein the custom parser is selected based on a type of the learning content;
parsing the at least one structured document using a generic parser to split the content into at least one learning object and to associate metadata with the at least one learning object.

2. The method of claim 1, wherein the type of the learning content is selected from the group consisting of hypertext markup language, word processing software document type, presentation software type, and image type.

3. The method of claim 1, wherein the at least one structured document includes at least one hypertext markup language document.

4. The method of claim 1, wherein the at least one structured document includes at least one extensible markup language document.

5. The method of claim 1, wherein the metadata is one of Learning Object Metadata compliant metadata or Shareable Content Object Reference Model compliant metadata.

6. The method of claim 1, wherein the generic parser generates IMS Manifest metadata and associates the IMS Manifest metadata with the at least one learning object.

7. The method of claim 1, further comprising:
populating a content repository with the metadata and the at least one learning object.

8. The method of claim 1, wherein a portion of the metadata is entered by a user.

9. An apparatus for creation of learning content, the apparatus comprising:
means for parsing learning content using a custom parser to form at least one structured document, wherein the custom parser is selected based on a type of the learning content;
means for parsing the at least one structured document using a generic parser to split the content into at least one learning object and to associate metadata with the at least one learning object.

10. The apparatus of claim 9, wherein the type of the learning content is selected from the group consisting of hypertext markup language, word processing software document type, presentation software type, and image type.

11. The apparatus of claim 9, wherein the at least one structured document includes at least one hypertext markup language document.

12. The apparatus of claim 9, wherein the at least one structured document includes at least one extensible markup language document.

13. The apparatus of claim 9, wherein the metadata is one of Learning Object Metadata compliant metadata or Shareable Content Object Reference Model compliant metadata.

14. The apparatus of claim 9, wherein the generic parser generates IMS Manifest metadata and associates the IMS Manifest metadata with the at least one learning object.

15. The apparatus of claim 9, further comprising:
means for populating a content repository with the metadata and the at least one learning object.

16. The apparatus of claim 9, wherein a portion of the metadata is entered by a user.

17. A computer program product, in a computer readable medium, for creation of learning content, the computer program product comprising:
instructions for parsing learning content using a custom parser to form at least one structured document, wherein the custom parser is selected based on a type of the learning content;
instructions for parsing the at least one structured document using a generic parser to split the content into at least one learning object and to associate metadata with the at least one learning object.

18. The computer program product of claim 17, wherein the metadata is one of Learning Object Metadata compliant metadata or Shareable Content Object Reference Model compliant metadata.

19. The computer program product of claim 17, wherein the generic parser generates IMS Manifest metadata and associates the IMS Manifest metadata with the at least one learning object.

20. The computer program product of claim 17, further comprising:
instructions for populating a content repository with the metadata and the at least one learning object.
